(19) United States
(12) Patent Application Publication
(10) Pub. No.: US 2020/0158859 A1
(43) Pub. Date: May 21, 2020

(54) Radar-Based Inspection System

(71) Applicant: Rapiscan Systems, Inc., Torrance, CA (US)

(72) Inventor: Edward James Morton, Guildford (GB)

(21) Appl. No.: 16/520,753

(22) Filed: Jul. 24, 2019

Related U.S. Application Data
(63) Continuation-in-part of application No. 15/859,777, filed on Jan. 2, 2018.
Application No. 15/859,777 is a continuation of application No. 14/639,956, filed on Mar. 5, 2015, now Pat. No. 9,891,314.
(60) Provisional application No. 62/702,868, filed on Jul. 24, 2018.
(60) Provisional application No. 62/702,841, filed on Jul. 24, 2018.
(60) Provisional application No. 62/702,833, filed on Jul. 24, 2018.
(60) Provisional application No. 61/949,775, filed on Mar. 7, 2014.

(51) Int. Cl. G01S 13/88; G01V 8/00; G01S 13/02; G01S 13/87

(52) U.S. Cl. CPC G01S 13/887; G01S 13/87; G01S 13/0209; G01V 8/005

(57) ABSTRACT

A portal for scanning a person walking through the portal, wherein the person is carrying at least one object on the person's body, the portal having first and second vertical sides connected at their tops by a horizontal side; a transceiver positioned on the horizontal side to propagate radiation downwards on the person and receive at least one of first, second and third scan data, wherein the first scan data corresponds to a front-view, the second scan data corresponds to a plan-view and the third scan data corresponds to a back-view of the person; and at least one processor associated with the transceiver to process at least one of the first, second and third scan data to determine a location and dielectric signature of the at least one object.

### CROSS-REFERENCE

The present application relies on U.S. Patent Provisional Application No. 62/702,833, entitled “Passive, Walk-Through Metal Detection System” and filed on Jul. 24, 2018, for priority.

The present application also relies on U.S. Patent Provisional Application No. 62/702,841 entitled “Radar-Based Inspection System” and filed on Jul. 24, 2018, for priority.

The present application also relies on U.S. Patent Provisional Application No. 62/702,868 entitled “Radar-Based Baggage and Parcel Inspection Systems” and filed on Jul. 24, 2018, for priority.

The present specification is also a continuation-in-part application of U.S. patent application Ser. No. 15/859,777, entitled “Ultra Wide Band Detectors”, filed on Jan. 2, 2018, which in turn, is a continuation application of U.S. patent application Ser. No. 14/639,956, entitled “Ultra Wide Band Detectors”, filed on Mar. 5, 2015, and issued as U.S. Pat. No. 9,891,314 on Feb. 13, 2018, which, in turn, relies on U.S. Patent Provisional No. 61/949,775, entitled “Ultra-Wide Band Detectors”, and filed on Mar. 7, 2014, for priority.

The present application relates to U.S. patent application Ser. No. 15/625,925, entitled “Detector Systems”, filed on Jun. 16, 2017, and issued as U.S. Pat. No 10,107,783 on Oct. 23, 2018, which is a continuation application of U.S. patent application Ser. No. 14/020,317, of the same title, filed on Sep. 6, 2013, and issued as U.S. Pat. No. 9,714,920 on Jul. 25, 2017, which is a continuation application of U.S. patent application Ser. No. 12/523,051, of the same title, filed on Jul. 13, 2009, and issued as U.S. Pat. No. 8,552,722 on Oct. 8, 2013, which is a national stage application of PCT Application No. PCT/GB2008/000116, filed on Jan. 15, 2008, which relies on Great Britain Patent Application Number 0703481.2, filed on Feb. 22, 2007 and Great Britain Patent Application Number 0700731.3, filed on Jan. 15, 2007, for priority.

All of the above-mentioned patents and patent applications are herein incorporated by reference in their entirety.

### FIELD

The present specification generally relates to a personnel screening system, and in particular, relates to a system for material-specific detection using non-ionizing radiation in which beams of electromagnetic radiation are projected at individuals as they walk through a portal.

### BACKGROUND

Terrorism poses a threat to the travelling public. Threat devices, such as weapons, or threat materials, such as explosives, may be carried in pockets or strapped to the body with little probability of detection by casual, or even skilled, observers. Therefore, it has become common practice to require travelers to divest themselves of outer garments, belts, wallets, jewelry, mobile phones, and shoes when entering or passing through a critical facility such as an airport, train depot, or public building. The divesting procedure is time consuming and inconvenient for members of the public and is expensive to manage for the facility operator.

Once divested, the garments and accessories are typically scanned using an X-ray transmission imaging system while the traveler or member of the public is scanned by a different piece of technology, such as a millimeter wave imaging system or an X-ray backscatter imaging system, to produce images of the body of the person being scanned. The images of the body may contain anomalies caused by items carried by the person. These anomalies may be innocuous items, such as a passport or a handkerchief, or may be significant threats, such as an explosive material. Currently, known technologies require a trained algorithm to analyze the shape of the detected object to determine if it is a threat or if it is innocuous. From the shape alone, however, it is difficult to assess the nature of many potential threats, or ascertain whether they are indeed innocuous items, and therefore false alarm rates tend to be significant.

Therefore, what is needed is a system for material specific detection using non-ionizing radiation in which beams of electromagnetic radiation are projected in rapid succession at a plurality of individuals as they walk through a portal.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a portal for scanning a person walking through said portal, wherein the person is carrying at least one object on the person's body, the portal comprising: a first vertically oriented panel having a first top edge; a second vertically oriented panel having a second top edge; a horizontally oriented panel, wherein the horizontally oriented panel is attached to the first top edge and the second top edge; a transceiver positioned on the horizontally oriented panel, wherein the transceiver is configured to propagate radiation downwards on the person and receive at least one of first, second or third scan data, wherein said first scan data corresponds to a front-view of the person, the second scan data corresponds to a plan-view of the person and the third scan data corresponds to a back-view of the person; and at least one processor associated with said transceiver to process said at least one of first, second or third scan data to determine a location and dielectric signature of the at least one object.

Optionally, the transceiver comprises a plurality of transmitter elements configured to project radiation onto the person and a plurality of receiver elements configured to receive scattered radiation from the person during at least one of a first, second or third phases of scanning.

Optionally, the first phase corresponds to the person approaching an entrance to the portal, the second phase corresponds to the person moving through the portal and the third phase corresponds to the person moving toward and through an exit of the portal.

Optionally, said transceiver propagates ultra-wide band radiation.

Optionally, said radiation has frequencies ranging between 8 GHz and 3000 GHz.

Optionally, said at least one of first, second or third scan data is generated at a rate ranging between 5 and 100 frames per second.

Optionally, said dielectric signature comprises permittivity and reflectivity.

Optionally, the portal further comprises a first plurality of magnetic field generators positioned on the first vertically oriented panel and configured to generate a magnetic field and a second plurality of magnetic field detectors on the second vertically oriented panel configured to measure a magnetic field modified by the at least one object.

Optionally, the at least one processor is in electric communication with the first plurality of magnetic field generators and the second plurality of magnetic field generators and configured to determine a magnetic signature of said at least one object. Optionally, the magnetic signature comprises a magnetic polarisability dyadic.

Optionally, the at least one processor generates at least one of a first, second or third point cloud images corresponding to said at least one of first, second or third scan data.

The present specification also discloses a method of scanning a person walking through a portal, wherein the person is carrying at least one object on the person's body, wherein said portal comprises a first vertical side with a first top edge, a second vertical side with a second top edge, and a horizontally oriented side that is connected to the first and second top edge and wherein the horizontally oriented side has a transceiver to propagate radiation downwards on the person, the method comprising: using the transceiver to acquire at least one of first scan data, second scan data or third scan data, wherein the first scan data corresponds to a front-view of the person, the second scan data corresponds to a plan-view of the person and the third scan data corresponds to a back-view of the person; and processing said at least one of first, second or third scan data to determine a location and dielectric signature of said at least one object.

Optionally, the transceiver comprises a plurality of transmitter elements configured to project radiation on the person and a plurality of receiver elements configured to receive scattered radiation from the person during at least one of a first phase of scanning, a second phase of scanning or a third phase of scanning, wherein the first phase corresponds to the person approaching an entrance of the portal, the second phase of scanning corresponds to the person moving through the portal, and the third phase of scanning corresponds to the person moving out of the portal.

Optionally, said transceiver propagates ultra-wide band radiation.

Optionally, said radiation has frequencies ranging between 8 GHz and 3000 GHz.

Optionally, said at least one of first scan data, second scan data or third scan data is generated at a rate ranging between 5 and 100 frames per second.

Optionally, said dielectric signature comprises values indicative of a permittivity and a reflectivity of the at least one object.

Optionally, a plurality of magnetic field generators is positioned on the first vertical side and configured to generate a magnetic field at the portal and a plurality of magnetic field detectors are positioned on the second vertical side for measuring a magnetic field modified by the at least one object.

Optionally, the processing comprises generating at least one of a first, second or third point cloud images corresponding to said at least one of first, second or third scan data.

Optionally, the processing comprises determining a magnetic signature of said at least one object. Optionally, the magnetic signature comprises a value indicative of a magnetic polarisability dyadic of the at least one object.

The present specification also discloses a scanning system comprising: a plurality of scanning nodes in communication with a network, wherein each of said scanning node defines a surveillance volume for scanning a person walking into said surveillance volume, wherein the person is carrying at least one object on the person's body, and wherein each of said plurality of scanning nodes comprises: a transceiver positioned to propagate radiation downwards on the person and receive at least one of first, second and third scan data, wherein said first scan data corresponds to a front-view, said second scan data corresponds to a plan-view and said third scan data corresponds to a back-view of the person; a processor to process said at least one of first, second and third scan data to determine a location and dielectric signature of said at least one object; and a server in communication with each of said plurality of scanning nodes to acquire, store and analyze said location and dielectric signature to resolve a threat alarm generated by the person walking into surveillance volumes of more than one of said plurality of scanning nodes.

Optionally, said plurality of scanning nodes comprise portal and non-portal type checkpoints.

The present specification also discloses a portal for scanning a person walking through said portal, wherein the person is carrying at least one object on the person's body, the portal comprising: first and second vertical sides connected at their tops by a horizontal side; a transceiver positioned on the horizontal side to propagate radiation downwards on the person and receive at least one of first, second and third scan data, wherein said first scan data corresponds to a front-view, said second scan data corresponds to a plan-view and said third scan data corresponds to a back-view of the person; and at least one processor associated with said transceiver to process said at least one of first, second and third scan data to determine a location and dielectric signature of said at least one object.

Optionally, the transceiver comprises a plurality of transmitter elements to project radiation on the person and a plurality of receiver elements to receive scattered radiation from the person during at least one of a first, second and third phases of scanning, wherein said first phase corresponds to the person approaching the portal, said second phase corresponds to the person moves through the portal and said third phase corresponds to the person moving past the portal.

Optionally, said transceiver propagates ultra-wide band radiation.

Optionally, said radiation has frequencies ranging between 8 GHz and 3000 GHz.

Optionally, said at least one of first, second and third scan data is generated at a rate ranging between 5 and 100 frames per second.

Optionally, said dielectric signature comprises permittivity and reflectivity.

Optionally, the portal further comprises a plurality of magnetic field generators positioned on said first side for generating a magnetic field at the portal and a plurality of magnetic field detectors on said second side for measuring a modified magnetic field, wherein the generated magnetic field is modified by said at least one object, and wherein said at least one processor is also associated with said magnetic field generators and detectors to determine a magnetic signature of said at least one object.

Optionally, said magnetic signature is a magnetic polarisability dyadic.

Optionally, said at least one processor generates at least one of a first, second and third point cloud images corresponding to said at least one of first, second and third scan data.

The present specification also discloses a method of scanning a person walking through a portal, wherein the person is carrying at least one object on the person's body, wherein said portal has first and second vertical sides connected at their tops by a horizontal side, and wherein said horizontal side supports a transceiver to propagate radiation downwards on the person, the method comprising: using the transceiver to acquire at least one of first, second and third scan data, wherein said first scan data corresponds to a front-view, said second scan data corresponds to a plan-view and said third scan data corresponds to a back-view of the person; and processing said at least one of first, second and third scan data to determine a location and dielectric signature of said at least one object.

Optionally, the transceiver comprises a plurality of transmitter elements to project radiation on the person and a plurality of receiver elements to receive scattered radiation from the person during at least one of a first, second and third phases of scanning, wherein said first phase corresponds to the person approaching the portal, said second phase corresponds to the person moves through the portal and said third phase corresponds to the person moving past the portal.

Optionally, said transceiver propagates ultra-wide band radiation.

Optionally, said radiation has frequencies ranging between 8 GHz and 3000 GHz.

Optionally, said at least one of first, second and third scan data is generated at a rate ranging between 5 and 100 frames per second.

Optionally, said dielectric signature comprises permittivity and reflectivity.

Optionally, a plurality of magnetic field generators are positioned on said first side for generating a magnetic field at the portal and a plurality of magnetic field detectors are positioned on said second side for measuring a modified magnetic field, wherein the generated magnetic field is modified by said at least one object, and wherein said processing includes determining a magnetic signature of said at least one object.

Optionally, said magnetic signature is a magnetic polarisability dyadic.

Optionally, said processing includes generating at least one of a first, second and third point cloud images corresponding to said at least one of first, second and third scan data.

The aforementioned and other embodiments of the present specification shall be described in greater depth in the drawings and detailed description provided below.

### BRIEF DESCRIPTION OF THE DRAWINGS

These and other features and advantages of the present specification will be further appreciated, as they become better understood by reference to the following detailed description when considered in connection with the accompanying drawings:

FIG. 1A is a schematic diagram of a non-ionizing electromagnetic radiation-based scanning and imaging system, in accordance with one embodiment of the present specification;

FIG. 1B illustrates a person approaching and walking-through the system of FIG. 1A, in accordance with an embodiment;

FIG. 2 illustrates a short Gaussian-like pulse of radiofrequency power in the time domain which maps to a broad wide band pulse of radiofrequency power in the frequency domain;

FIG. 3 illustrates an embodiment of a radar transceiver system or circuit for the scanning and imaging system of the present specification;

FIG. 4 is a flow chart illustrating a plurality of steps in accordance with an embodiment of a method of detection, localization, characterization and classification of an object carried by a person walking through the scanning and imaging system of the present specification; and

FIG. 5 illustrates a plurality of scanning nodes in communication with a server through a network, in accordance with an embodiment of the present specification.

### DETAILED DESCRIPTION

This specification discloses methods and systems for detecting concealed weapons and other contraband using radar scanning and imaging systems that employ active array antennas. Such radar scanning and imaging systems are applicable to many types of security concerns, such as screening people for both concealed weapons (including non-metallic weapons) or explosives at airports and other public buildings. One or more embodiments provides a walk-through scanning station or portal for screening individuals that can detect, for example, an improvised explosive device (IED) concealed on a person, yet may be considered as being non-invasive of privacy. The portal employs a transceiver system (comprising phased antenna array) to propagate non-ionizing electromagnetic radiation at a person as he approaches and walks through the portal. The portal is configured to be readily deployed, for example, around the entrances of stadiums, government agency offices, banks, voting lines, religious gathering places, markets, public gatherings, and high impact assets.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise” “include” and “have”, and forms thereof, are not necessarily limited to members in a list with which the words may be associated. It should be noted herein that any feature or component described in association with a specific embodiment may be used and implemented with any other embodiment unless clearly indicated otherwise.

As used herein, the indefinite articles “a” and “an” mean “at least one” or “one or more” unless the context clearly dictates otherwise.

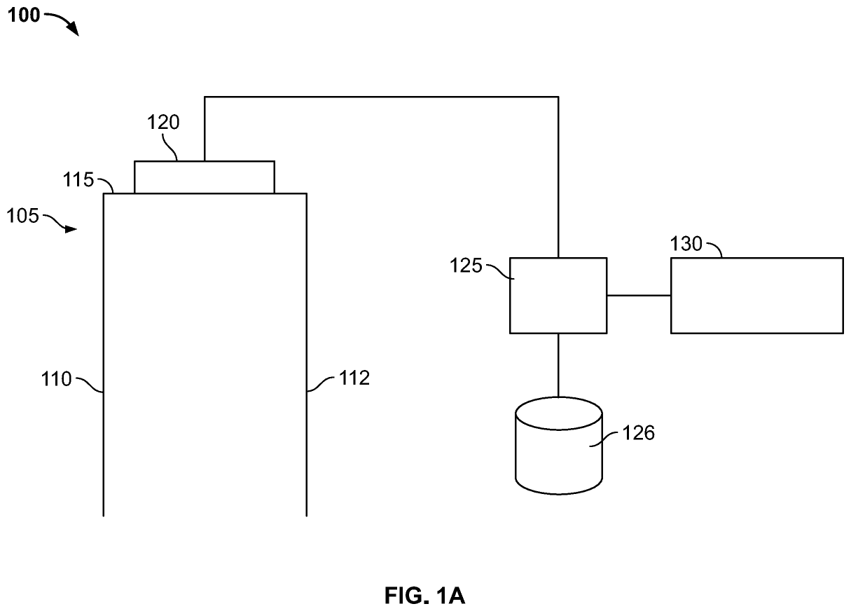

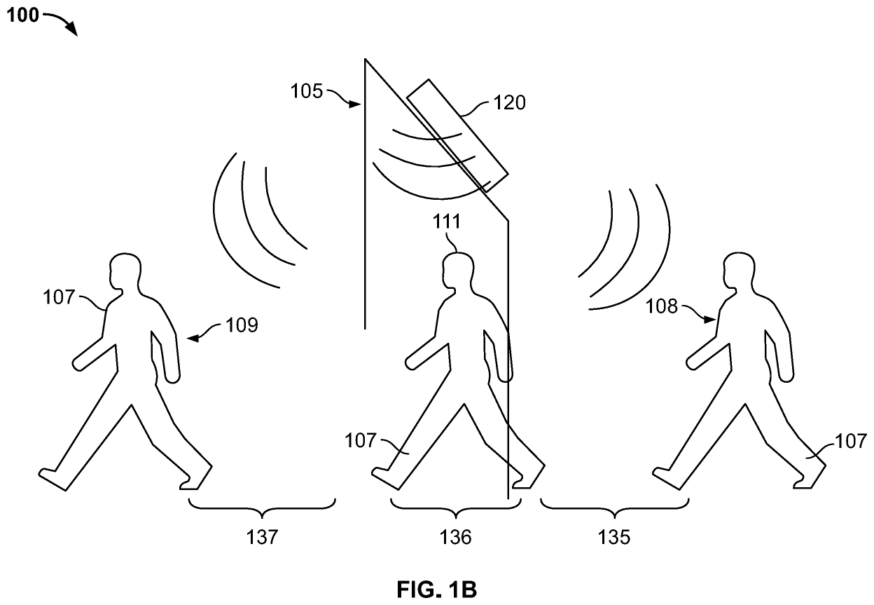

FIG. 1A shows an embodiment of a non-ionizing radiation based scanning and imaging system 100 suitable for people screening at transit points such as at airports, malls, cinema halls, doorways, ticket gates and pedestrian crossings, without requiring people to divest themselves of garments or accessories. FIG. 1B illustrates a person approaching and walking through the system 100, in accordance with an embodiment. Referring now to FIGS. 1A and 1B together, the system 100 is configured, in one embodiment, in the form of a walk through portal, gate or archway 105 comprising first and second vertical sides or panels 110, 112 connected at the top by a horizontal side, roof, cover or hood 115. In accordance with an embodiment, the roof 115 supports a radar transceiver system 120 to propagate non-ionizing electromagnetic radiation downwards (top-down propagation, direction or trajectory) on a person 107 approaching and walking through the portal 105.

It should be appreciated that positioning the transceiver system 120 at the roof 115 has advantages such as: a) in situations where the portal is actually a doorway with a sliding door, for example, as a result of which presence of the transceiver system 120 on the sides of the doorway may be less optimal and may suffer from obstructions to scanning; b) it is more convenient to resolve individual people in a queue using a top down rather than side pointing transceiver since people are more uniform in height but may occupy the left or right side of the portal which could obscure the required signal; and c) it may be harder to reach (and potentially disable) the transceiver at the roof rather than one mounted on the vertical sides of the portal. Accordingly, it should be appreciated that the presently disclosed embodiments may be integrated into a door, a hallway, a gate, and/or any form of controlled entrance or exit.

The radar transceiver system 120 includes a plurality of transmitting and receiving antenna elements Tx/Rx, in accordance with some embodiments. However, in other embodiments, each antenna element is capable of producing and transmitting electromagnetic radiation and each is capable of receiving and capturing reflected radiation. Some embodiments may include implementation of a fully integrated, FCC compliant transceiver system 120 including a plurality of transmitter elements Tx fully integrated with an array of power amplifiers and corresponding antenna arrays to form spatial power combining and narrow beam forming; and including a plurality of receiver elements Rx fully integrated with an array of low noise amplifiers and corresponding antenna arrays to form spatial power combining from a reflected signal. Various embodiments may include implementation of an array of polarized miniature antenna elements that enable system capabilities for analysis of scanned material and differentiation and classification of scanned material according to radar signature profiles, point cloud images or radar scan information.

In some embodiments, each transceiver of the radar transceiver system 120 may be an UWB (Ultra Wide Band) radar transceiver operating at a center frequency, for example, of about 60 GHz. In some embodiments, the radar transceiver system 120 may transmit a radar signal in X-band (for example, about 8-12 giga-Hertz (GHz)), V-band (for example, about 40-75 giga-Hertz (GHz)), E-band (for example, including two bands of about 71-76 and 81-86 GHz), W-band (for example, about 75-110 GHz), or terahertz (for example, about 300-3000 GHz) frequency bands. Some embodiments may employ 5 GHz ultra wide band (UWB) radar operating at 1-6 GHz, for example, or 3-6 GHz. In various embodiments, the transceiver system 120 may use one or more of the aforementioned bands of frequencies. For example, some embodiments may use radiation in the X-band for low resolution, high penetration imaging and E-band for high resolution, low penetration imaging.

The system 100 further includes at least one processor 125, computer-readable medium or memory 126 and a display 130. The processor 125 includes any hardware, software, firmware, or combination thereof for controlling the radar transceiver system 120 and processing the received electromagnetic radiation reflected from the person for use in constructing a radar image of the person 107. For example, the processor 125 may include one or more microprocessors, microcontrollers, programmable logic devices, digital signal processors or other type of processing devices that are configured to execute instructions of a computer program, and one or more memories (for example, cache memory) that store the instructions and other data used by the processor 125. The memory 126 includes any type of data storage device, including but not limited to, a hard drive, random access memory (RAM), read only memory (ROM), compact disc, floppy disc, ZIP® drive, tape drive, database or other type of storage device or storage medium.

It would be evident to those of ordinary skill in the art that as the person 107 walks through the system 100, the position of each interacting surface on the person 107 changes continually. Therefore, in accordance with an aspect of the present specification, the person 107 or the detection space and/or region (that is, the passage defined by the portal 105) is scanned or sampled multiple times during the transit of the person 107 through the system 100. Since data collection for each transmitter pulse with parallel data collection on all receivers occurs in time periods of nanoseconds (and less than 100 ns), and there can be 100 to 1000 transmitter elements in the system 100, it is possible to complete data collection in time periods of less than 1 millisecond. The complete data collection operation may be understood to generate a “frame” of data. In accordance with an aspect, for each transmitter, a plurality of scan data measurements or repeat/multiple scan data measurements are taken to gain improved signal to noise ratios while the overall frame rate is maintained at a value between 5 and 100 frames per second. Accordingly, with a person walking at speeds between 0.2 and 2 meters per second (m/s), the system provides at least 5 inspection frames per second for a fast walking person, with high signal to noise ratio signal acquisition, and over 100 frames per second for a slow moving person, with reduced signal to noise ratio signal acquisition. At these frame rates, the system 100 captures a high integrity data set multiple times for a moving person, thereby enabling an effective walk through system as opposed to a static “pose and scan” system known in the art.

Thus, in accordance with an aspect, the system 100 operates in multi-frame inspection mode wherein a plurality of scan data sets are collected for the person as he passes through the portal to provide several measurements of threat type and location and to enable probing of hidden or difficult to scan locations/regions on the person's body.

The processor 125 operates to program the radar transceiver system 120 to irradiate or illuminate the person 107 approaching and walking through the portal 105. As shown in FIG. 1B, as the person 107 approaches the portal 105, during a first phase 135 of scanning, the electromagnetic radiation from the transceiver system 120 illuminates the person's front surface 108 (front-view). As the person 107 walks through the portal 105, during a second phase 136 of scanning, the transceiver system 120 illuminates the person 107 in an overhead-view, plan-view or top-down view 111. Whereas, as the person 107 walks past and away from the portal 105, during a third phase 137 of scanning, the electromagnetic radiation from the transceiver system 120 illuminates the person's back surface 109 (back-view).

It should be appreciated that while in some embodiments, all three phases of scanning are implemented, in alternate embodiments only the first and second phases may be implemented while in still other embodiments only the second phase may be implemented. In other words, in some embodiments all three views, that is front, plan and back views, of the person are acquired, in alternate embodiments only front and plan views are acquired while in still other embodiments only the plan-view is acquired.

A preferred embodiment implements at least the first and second phases to determine the 3D shape of one or more objects, such as an IED vest, located on the body surface of the person 107. Use of scan data corresponding to front and plan views enables determination of a thickness of the one or more objects as well as the dielectric properties, such as the dielectric constant, of the material of the one or more objects.

In exemplary embodiments, the processor 125 programs respective amplitude/phase delays or amplitude/phase shifts into each of the individual antenna elements in the radar transceiver system 120 to appropriately irradiate or illuminate the person 107 during each of the first, second and third phases 135, 136, 137 of scanning. In addition, the processor 125 programs respective amplitude/phase delays or amplitude/phase shifts into each of the individual antenna elements to receive reflected electromagnetic illumination from the person 107 corresponding to each of the first, second and third phases 135, 136, 137 of scanning. In embodiments using phase shifts, the programmed phase shifts can be either binary phase shifts, some other multiple number of phase shifts or continuous phase shifts.

The processor 125 executes a plurality of instructions to process scan data and construct radar signature profiles or point cloud representations or images of a surface beneath the clothing of the person 107 and utilize the point cloud representations to localize, characterize and classify items carried on or attached to the surface of the skin and/or carried beneath the clothing of the person 107. In some embodiments, the processor 125 generates first, second and third point cloud images respectively associated with the person's front-view, overhead-view or plan-view and back-view that correspond to the first, second and third phases 135, 136, 137 of scanning. It should be appreciated, that each of the first, second and third point cloud image provides scan information from a differing angle of viewing, irradiation or illumination of the person 107. The radar signature profile or scan information or point cloud images corresponding to at least one of the first, second and third phases 135, 136, 137 enables localization, characterization and classification of threat and innocuous items.

In various embodiments, the processor 125 analyses radar signature profile or point cloud images corresponding to at least one of the first, second and third phases 135, 136, 137 to determine the dielectric properties or tensor signatures such as, but not limited to, dielectric constant, conductivity, permittivity, permeability and/or reflectivity for each point on the point cloud images and consequently of one or more items carried by the person 107 on the top and/or beneath the clothing.

The resulting point cloud images of the person 107 can be passed from the processor 125 to the display 130 to display the images. In one embodiment, the display 130 is a two-dimensional display for displaying three-dimensional point cloud images of the person 107 or one or more one-dimensional or two-dimensional point cloud images of the person 107. In another embodiment, the display 130 is a three-dimensional display capable of displaying three-dimensional point cloud images of the person 107. Display 130 may be attached to or supported in proximity to the portal 105 or may be remotely located and communicate with the radar transceiver system 120 via, for example, a secure, wireless connection. In order to address privacy issues and concerns, images may be provided by display 130 as an abstract figure (for example, outline or line drawing type of images of the person 107).

In various embodiments, the system 100 is configured to detect threat objects (carried on the person 107 and/or concealed by the person 107 under clothing) at a distance of up to 50 meters from the portal 105. In some embodiments, the threat objects are detectable at a distance ranging from 5 to 10 meters from the portal 105.

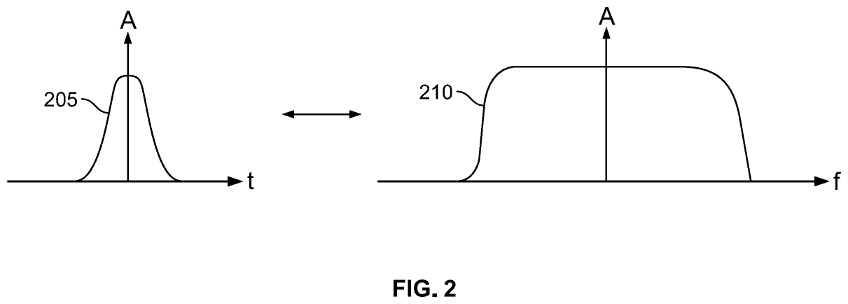

FIG. 2 shows a short Gaussian like pulse 205 of radiofrequency power in the time domain (left hand side) which maps to a broad wide band pulse 210 of radiofrequency power in the frequency domain (right hand side), of typical duration less than 1 ns. In frequency space, the pulse equates to a wide Gaussian extending out to many GHz in cut-off frequency. This stimulating pulse 205, when applied to a suitable antenna with broad frequency response, provides an ultra-wide band microwave beam (for use in the scanning/imaging system of the present specification) which interacts with the person approaching and walking through the scanning system of the present specification. Since the pulse 205 is very narrow, the receiving antenna detects the arrival of the interacted beam pulse some time, ‘delta t’, later due to the time of flight of the pulse which travels at the speed of light (3×10⁸ m/s in vacuum).

Since the velocity of propagation of a transmitted electromagnetic beam through a threat object is dependent on its dielectric property (the velocity of propagation is slowed as it passes through the object), the surface of the person's body appears to be indented behind the object in direct proportion to the relative permittivity/dielectric property of the threat object. This information is used in reconstructing the threat location, shape, size and type in subsequent signal analysis procedures. In accordance with an embodiment, a projection of ultra wide band radio frequencies from each transmitter element to the array of detection/receiver elements allows the physical location and dimensions of a potential threat object located in a pocket or on the surface of the body of the person to be determined using simple ray tracing methods known to persons of ordinary skill in the art. Alternately, in the frequency domain, it is known to persons skilled in the art that the strongest interaction of a radio frequency signal with a dielectric object occurs at an integer divisor of the wavelength of the electromagnetic beam. Therefore, in one embodiment, the dimension of an object is determined by spectral analysis of the reflected electromagnetic beam--wherein a plurality of notches due to object attenuation is characteristic of the dimensions of the object.

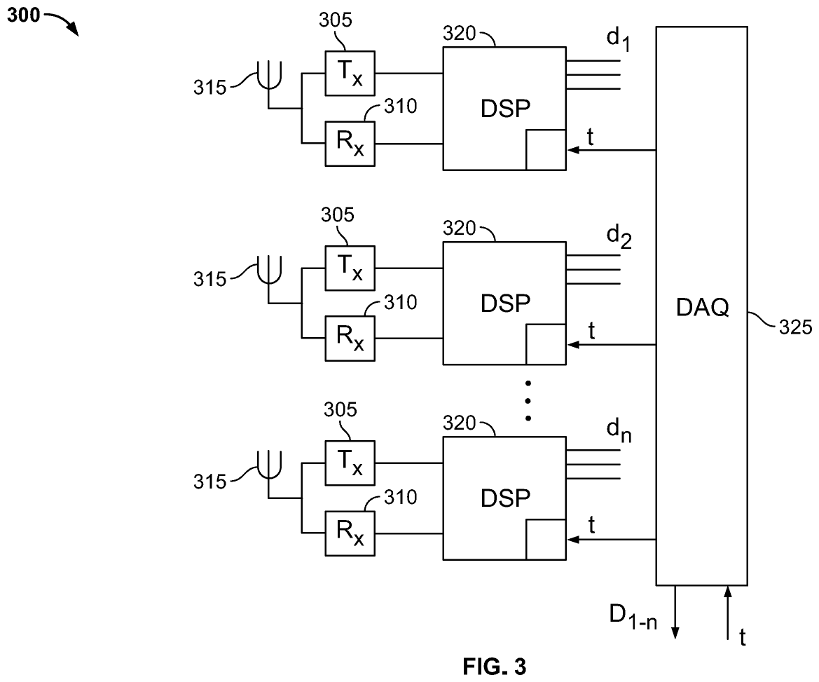

FIG. 3 shows an embodiment of a radar transceiver system or circuit 300 for the imaging/scanning system of the present specification. In this embodiment, transmit (Tx) and receive (Rx) amplifiers are connected to a common antenna. While transmitting, the receiver channel is disconnected. The Tx/Rx amplifiers are connected to individual digital signal processing (DSP) blocks which receive precise timing and phase control information from a host data acquisition system (DAQ). Processed data from the DSP blocks is managed by the DAQ and results in high bandwidth projection data being generated which is passed to a threat reconstruction and detection processor for analysis.

Referring now to FIG. 3, each antenna 315 is connected to a transmitter circuit 305, Tx, and a receiver circuit 310, Rx. The receiver circuit 310 includes a switch in series with its input to disconnect the receiver input circuitry when the transmitter is active. Similarly, the transmitter includes a switch in series with its output to disconnect it from the antenna when it is not active so that it does not load the receiver input circuits. Amplifiers of the Tx and Rx circuits 305, 310 are connected to a digital signal processor (DSP) 320, one DSP 320 for each Tx/Rx pair. The DSP element 320 is typically formed from digital and analogue circuits including analogue-to-digital converters, digital-to-analogue converters, field programmable gate arrays, microprocessors and full custom mixed signal integrated circuits. The function of the DSP 320 is to generate the transmitter output signals, to condition and process the receiver input signals and to provide a digital output projection data stream that conveys the time, phase or frequency domain information, about the interacted beams, necessary for an efficient implementation of subsequent threat reconstruction algorithms. A high bandwidth data acquisition system (DAQ) 325 manages the collection of projection data from each Tx/Rx pair 305, 310 and provides precise timing information, t, to ensure accurate synchronization of each system element. As is generally the case for high speed timing systems, the DAQ 325 takes an input time stamp, generally a precise clock with low timing jitter at relatively low frequency and self-calibrates the time presented by each Tx/Rx unit 305, 310 by sending out known times, t, and then recording the time at which a return message was received back to the DAQ 325, the time offset then being taken at half this total loop time. Thus, in various embodiments, the radar transceiver system or circuit 400 performs a plurality of functions such as, but not limited to, transmitter output signal generation, reflected, received or scan data acquisition, normalization, background offset removal, filtering and serial data transmission.

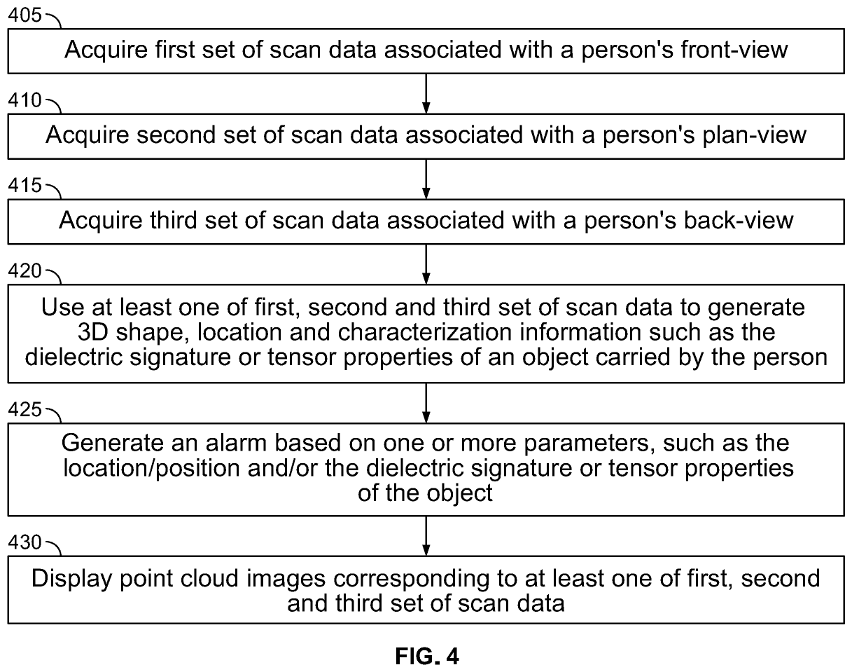

FIG. 4 is a flow chart illustrating a plurality of steps in accordance with an embodiment of a method of detection, localization, characterization and classification of an object carried by a person walking through a portal of the scanning/imaging system 100 of FIGS. 1A, 1B.

Referring now to FIG. 4 along with FIGS. 1A, 1B, at step 405 the person carrying the object is illuminated with non-ionizing electromagnetic radiation to acquire a first set of scan data corresponding to a first phase of scanning when the person approaches or walks towards the portal 105. The first set of scan data is associated with the person's front-view. At step 410, in a second phase of scanning when the person is walking-through the portal 105, a second set of scan data is acquired. The second set of scan data is associated with the person's plan-view or overhead-view. At step 415, in a third phase of scanning when the person walks away from the portal 105, a third set of scan data is acquired. The third set of scan data is associated with the person's back-view.

It should be appreciated that while in some embodiments, all three steps 405, 410 and 415 are implemented, and in alternate embodiments, only steps 405, 410 may be implemented while in still other embodiments only step 405 may be implemented. In other words, in some embodiments first, second and third scan data are acquired, in alternate embodiments only first and second scan data are acquired while in still other embodiments only the second scan data is acquired.

At step 420, the scan data from at least one of steps 405, 410, 415 is fed to the processor 125 to generate 3D shape, location and characterization information such as the dielectric signature or tensor properties of the object carried by the person.

In order to determine 3D shape information from the scan data set, various inverse problem solution techniques are adopted. For example, the scan data is arranged in matrix form for standard numerical matrix inversion. Alternatively, constrained iterative solver techniques may be employed which are generally more computationally efficient than basic matrix inversion.

In order to constrain the solver or matrix inversion problem, it is efficient to provide the algorithm with the three-dimensional shape of the person under inspection. This is efficiently achieved by using a video camera system in which a grid of infra-red beams is projected onto the surface of the person as he walks through the scanning/imaging system of the present specification and from the distortion of these beams which are observed by the video camera, a surface profile can be determined. Typically, two or more cameras are required to achieve a full 3D surface profile of the person. Other mechanisms are known to those skilled in the art, such as projecting divergent infra-red pencil beams onto the body surface and measuring the distance between interacting spots from these beams.

The object (carried on the person) is then described in terms of a suitable coordinate system, such as a 3D Cartesian matrix. Alternative systems, such as cylindrical coordinates, can also be useful.

Taking into account phase and frequency information, as well as spatial information, the tensor properties or dielectric signatures (such as the dielectric constant, conductivity, permittivity, permeability and/or reflectivity) of the object under inspection are determined.

At step 425, the scanning system 100 generates an alarm based on one or more parameters, such as the location/position and/or the dielectric signature or tensor properties determined in step 420, as the characteristic data for the object. A classification method is applied to the characteristic data for this purpose. The classification method is used to determine the significance of the threat (whether the object is innocuous, benign, explosive, weapon, Improvised Explosive Device) and the category or type of the threat (mobile phone, passport, explosive material, and/or knife). Classification techniques such as the k^{th} nearest neighbor (KNN), known to persons of ordinary skill in the art, may be used to determine the threat nature of the measured set of tensor properties/dielectric signatures and the residual error between the model and measurements can also be used to provide a confidence parameter on the classification.

If any detected object falls in the threat category, an alarm is activated. As is evident to those of ordinary skill in the art, various other object categories could be defined and used for particular classification purposes.

At step 430, point cloud images corresponding to scan data acquired in steps 405, 410 and/or 415 are displayed to an operator along with a visual indication of the significance and category of threat detected, if any.

### Network of Radar Based Scanning Systems

In accordance with various aspects, a plurality of radar based scanning and imaging systems, such as the system 100 (FIG. 1A) of the present specification are networked together for communication through a centralized processing or server system.

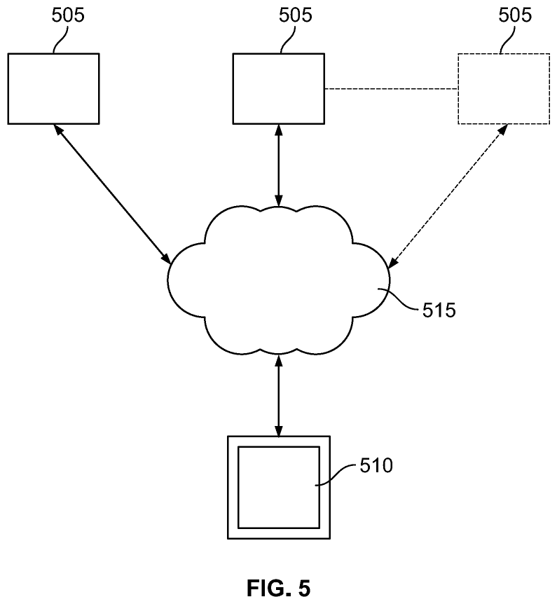

FIG. 5 illustrates a plurality of scanning nodes 505 in communication with a master or centralized server or processing system 510 through a network 515, which may be a private secured network or a secured Cloud-based network, for example. In some embodiments, each of the scanning nodes 505 are similar to the scanning and imaging system 100 of FIG. 1A.

Referring back to FIG. 1A, It should be appreciated that while in some embodiments, the system 100 is configured as a portal or archway 105 in various alternate embodiments, the system 100 is configured as a ubiquitous scanning node such as a pedestrian crossing pole/post, traffic lights pole, or turnstiles to entry and exit points of facilities such as, but not limited to, railway stations, malls, and concert sites. In other words, the teachings of the present specification are not constrained to an archway, gate, doorway or portal type of scanning structure and are extended to a variety of non-portal type check-points or scanning nodes that may not define a substantially rectangular surveillance walk-through volumes or zones. These scanning nodes are more like informal check-points with the transceiver system 120 positioned at an overhead location at these scanning nodes to scan individuals walking by, past or around these scanning nodes and therefore through or into their respective surveillance volumes. Accordingly, in various embodiments, the scanning nodes 505 of FIG. 5 comprise both portal as well as non-portal type of scanning systems.

Referring back to FIG. 5, in embodiments, scan data as well as alarm, threat or no-threat decisions from the plurality of scanning nodes 505 are communicated, stored and analyzed at the processing system 510. Networking of the scanning nodes 505 enables various advantages such as: ability to track a person through multiple scanning zones of the nodes 505 to (a) confirm the presence of a threat or otherwise clear an alarm, and (b) review potential threats against an evolving normal, innocuous, benign or no-threat data set from all the other scan data that has been collected from other scanning nodes. This enables implementation of deep learning algorithms to provide a second opinion on the threat result from an individual alarming scanning node.

### Integration with a Metal Detection System

In accordance with an aspect, the non-ionizing radiation based scanning and imaging system 100 (FIG. 1A) of the present specification is integrated with a metal detector. Referring back to FIG. 1A, in an embodiment, the portal 105 also includes active or passive metal detector system in addition to the radar transceiver system 120. In embodiments of an active metal detector system, the portal 105 comprises a plurality of magnetic field generators which, in one embodiment, are transmitter coils and a plurality of magnetic field detectors, which, in one embodiment, are receiver coils located respectively in the first and second vertical sides or panels 110, 112. In embodiments of a passive metal detector system, the portal 105 comprises a plurality of magnetometers positioned on the first and second vertical sides or panels 110, 112 to detect perturbations in the earth's magnetic field caused by ferrous objects passing through the portal 105.

The metal detector system provides location/position and magnetic signatures, such as the magnetic polarizability dyadic, of ferrous objects. Accordingly, in embodiments, radar signature profiles or dielectric properties determined using the radar based system 100 are used in conjunction with magnetic signatures to localize, characterize and classify dielectric as well as ferrous objects carried and/or concealed by a person in and/or underneath his clothing.

The above examples are merely illustrative of the many applications of the methods and systems of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A portal for scanning a person walking through said portal, wherein the person is carrying at least one object on the person's body, the portal comprising:
a first vertically oriented panel having a first top edge;
a second vertically oriented panel having a second top edge;
a horizontally oriented panel, wherein the horizontally oriented panel is attached to the first top edge and the second top edge;
a transceiver positioned on the horizontally oriented panel, wherein the transceiver is configured to propagate radiation downwards on the person and receive at least one of first, second or third scan data, wherein said first scan data corresponds to a front-view of the person, the second scan data corresponds to a plan-view of the person and the third scan data corresponds to a back-view of the person; and
at least one processor associated with said transceiver to process said at least one of first, second or third scan data to determine a location and dielectric signature of the at least one object.

2. The portal of claim 1, wherein the transceiver comprises a plurality of transmitter elements configured to project radiation onto the person and a plurality of receiver elements configured to receive scattered radiation from the person during at least one of a first, second or third phases of scanning.

3. The portal of claim 1, wherein the first phase corresponds to the person approaching an entrance to the portal, the second phase corresponds to the person moving through the portal and the third phase corresponds to the person moving toward and through an exit of the portal.

4. The portal of claim 1, wherein said transceiver propagates ultra-wide band radiation.

5. The portal of claim 1, wherein said radiation has frequencies ranging between 8 GHz and 3000 GHz.

6. The portal of claim 1, wherein said at least one of first, second or third scan data is generated at a rate ranging between 5 and 100 frames per second.

7. The portal of claim 1, wherein said dielectric signature comprises permittivity and reflectivity.

8. The portal of claim 1, further comprising a first plurality of magnetic field generators positioned on the first vertically oriented panel and configured to generate a magnetic field and a second plurality of magnetic field detectors on the second vertically oriented panel configured to measure a magnetic field modified by the at least one object.

9. The portal of claim 1, wherein the at least one processor is in electric communication with the first plurality of magnetic field generators and the second plurality of magnetic field generators and configured to determine a magnetic signature of said at least one object.

10. The portal of claim 9, wherein the magnetic signature comprises a magnetic polarisability dyadic.

11. The portal of claim 1, wherein the at least one processor generates at least one of a first, second or third point cloud images corresponding to said at least one of first, second or third scan data.

12. A method of scanning a person walking through a portal, wherein the person is carrying at least one object on the person's body, wherein said portal comprises a first vertical side with a first top edge, a second vertical side with a second top edge, and a horizontally oriented side that is connected to the first and second top edge and wherein the horizontally oriented side has a transceiver to propagate radiation downwards on the person, the method comprising:
using the transceiver to acquire at least one of first scan data, second scan data or third scan data, wherein the first scan data corresponds to a front-view of the person, the second scan data corresponds to a plan-view of the person and the third scan data corresponds to a back-view of the person; and
processing said at least one of first, second or third scan data to determine a location and dielectric signature of said at least one object.

13. The method of claim 12, wherein the transceiver comprises a plurality of transmitter elements configured to project radiation on the person and a plurality of receiver elements configured to receive scattered radiation from the person during at least one of a first phase of scanning, a second phase of scanning or a third phase of scanning, wherein the first phase corresponds to the person approaching an entrance of the portal, the second phase of scanning corresponds to the person moving through the portal, and the third phase of scanning corresponds to the person moving out of the portal.

14. The method of claim 12, wherein said transceiver propagates ultra-wide band radiation.

15. The method of claim 12, wherein said radiation has frequencies ranging between 8 GHz and 3000 GHz.

16. The method of claim 12, wherein said at least one of first scan data, second scan data or third scan data is generated at a rate ranging between 5 and 100 frames per second.

17. The method of claim 12, wherein said dielectric signature comprises values indicative of a permittivity and a reflectivity of the at least one object.

18. The method of claim 12, wherein a plurality of magnetic field generators is positioned on the first vertical side and configured to generate a magnetic field at the portal and a plurality of magnetic field detectors are positioned on the second vertical side for measuring a magnetic field modified by the at least one object.

19. The method of claim 12, wherein the processing comprises determining a magnetic signature of said at least one object

20. The method of claim 19, wherein the magnetic signature comprises a value indicative of a magnetic polarisability dyadic of the at least one object.

21. The method of claim 12, wherein the processing comprises generating at least one of a first, second or third point cloud images corresponding to said at least one of first, second or third scan data.
